(19) United States
(12) Patent Application Publication
(10) Pub. No.: US 2009/0119000 A1
(43) Pub. Date: May 7, 2009

(54) Method and Device for Determining Mass-Related Variables of a Vehicle

(75) Inventors: Peter BAUMANN, Gaggenau (DE); Markus MAI, Kuppenheim (DE); Karl-Heinz METZ, Gaggenau (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 11/793,252

(22) PCT Filed: Dec. 16, 2005
(86) PCT No.: PCT/EP05/13581

§ 371 Date: Jul. 28, 2008

(30) Foreign Application Priority Data
Dec. 17, 2004 (DE) 10 2004 060 809.1

(51) Int. Cl. B60G 17/016

(52) U.S. Cl. 701/124

(57) ABSTRACT

A method for determining mass-related variables of a vehicle is described. Spring compression travel values (L_{e,1}, L_{e,r}) are measured on at least one sprung axle of the vehicle, and an actual value (z_{s,1}) for the height of the center of gravity of the vehicle is determined from the measured spring compression travel values (L_{e,1}, L_{e,r}), their temporal variation (\dot{L}_{e,1}, \dot{L}_{e,r}), and at least one transversal dynamics variable which describes the transversal dynamics of the vehicle.

### CROSS REFERENCE TO RELATED APPLICATIONS

This application is a National Phase of PCT International Application No. PCT/EP2005/013581, filed Dec. 16, 2005, which claims priority under 35 U.S.C. § 119 to German Patent Application No. 10 2004 060 809.1 filed Dec. 17, 2004, the entire disclosures of which are herein expressly incorporated by reference.

### BACKGROUND AND SUMMARY OF THE INVENTION

The invention relates to a method and apparatus for determining mass-related variables of a vehicle, in which spring compression travel values are measured on at least one sprung axle of the vehicle.

In a vehicle which is equipped with an electronic stabilization system, the position of the center of gravity, in particular the height of the center of gravity, is especially importance for the driving safety and the driving behavior of the vehicle.

German Patent Document DE 100 29 332 A1 discloses a method and a device for measuring the load distribution of a vehicle having at least one axle with pneumatic suspension. In each case a travel sensor for determining the spring compression travel value and a pressure sensor for determining the wheel load are arranged on the wheel's suspension elements of the axle with pneumatic suspension. The wheel loads are calculated from the sensor data, and both the load distribution and the total weight of the vehicle are calculated therefrom.

German Patent Document DE 199 04 216 A1 also discloses a method and a device for determining and detecting the risk of a vehicle tilting, variations in the center of gravity of the vehicle during cornering being determined and compared with reference values. In order to determine the center of gravity, the wheel loads on at least one axle of the vehicle with leaf suspension are determined, specifically when a height level control device is present, by using a pressure sensor and otherwise by using a travel sensor. In order to determine the variation in the center of gravity it is also possible to use further variables which are characteristic of cornering, such as steering angle, wheel speeds, transversal acceleration, vehicle speed or yaw rate.

One object of the present invention is to make available a method and a device with which the actual center of gravity of the vehicle, in particular the height of the center of gravity of the vehicle, can be determined reliably.

This and other objects and advantages are achieved by the method and apparatus according to the invention, in which an actual value for the height of the center of gravity of the vehicle is determined from the measured spring compression travel values and their temporal variation, and at least one transversal dynamics variable which describes the transversal dynamics of the vehicle. On the basis of the actual value of the height of the center of gravity it is possible, in particular when the dimensions of the vehicle are known, to classify the vertical load distribution of the vehicle. That is, it is possible to determine whether the center of gravity is arranged in a lower region (low load), in a central region (central load) or in an upper region (high load) of the vehicle.

In one advantageous variant, wheel loads are measured on at least one sprung axle of the vehicle, and an actual value for the center of gravity in the longitudinal and/or transversal direction of the vehicle, and/or an actual value for the total weight of the vehicle is/are determined from the wheel loads. On the basis of the actual value of the center of gravity in the longitudinal direction of the vehicle it is possible to detect, in one embodiment, whether the vehicle is top heavy, rear heavy or loaded in a balanced fashion. On the basis of the actual value of the center of gravity in the transversal direction of the vehicle, one-sided loading or one-sided charging of the vehicle and the like can be determined. Furthermore, the actual value of the total weight of the vehicle can be used in order to determine whether the vehicle is fully laden, partially laden or unladen.

In an advantageous embodiment of the method, a second value for the height of the center of gravity of the vehicle is determined from wheel loads which are measured on at least one sprung axle of the vehicle and their temporal variation, and at least one transversal dynamics variable which describes the transversal dynamics of the vehicle, wherein an end value for the height of the center of gravity of the vehicle is determined from the actual value and the second value. The determination of the height of the center of gravity of the vehicle from the actual value and the second value by using a suitable weighting, for example by forming average values, can be carried out considerably more precisely by specifying the respective end value than would be possible by simply specifying the actual value. Furthermore, the second value can be used to check the actual value so that possible measuring errors can be detected.

In one advantageous embodiment, a second value for the center of gravity in the longitudinal and/or transversal direction of the vehicle, and/or a second value for the total weight of the vehicle is/are determined on the basis of a mass calculation of an electro-pneumatic brake system of the vehicle. Respectively associated end values for the center of gravity in the transversal and/or longitudinal direction of the vehicle, and/or the total weight of the vehicle are determined from the actual values and the second values. By using the actual values and the second values it is possible to precisely determine the center of gravity in the transversal direction of the vehicle, the center of gravity in the longitudinal direction of the vehicle and the total weight of the vehicle by specifying the respective end values in a way which is analogous to determining the end value of the height of the center of gravity.

In a further advantageous variant, a steering angle and/or a transversal acceleration and/or a vehicle speed and/or a yaw rate and/or a steering speed and/or a wheel speed and/or a vehicle basic stabilization system is/are used as transversal dynamics variables. The actual center of gravity of the vehicle can be determined reliably from one or more of these variables in conjunction with the spring compression travel values and/or wheel loads measured on the at least one sprung axle of the vehicle.

It is possible to determine the center of gravity of the vehicle on a plurality of ways which are independent of one another, wherein one or more of the abovementioned variables are combined with the measured spring compression travel values and/or wheel loads for each route, but the variables used on the different ways differ from one another. Mutual checking of the values acquired independently of one another for the center of gravity of the vehicle in this way can also be carried out.

In a further preferred embodiment, the vehicle is a commercial vehicle with a semi-trailer, wherein the actual values and the second values are determined both for the commercial vehicle and for the semi-trailer. If the commercial vehicle has a steel sprung front axle, the instantaneous total weight of the towing vehicle can be determined from the knowledge of the fifth wheel lead and the load on the rear axle of the vehicle.

In an alternative embodiment, the vehicle may be a towing vehicle with a trailer, and the actual values and the second values are determined both for the towing vehicle and for the trailer. Given knowledge of the total load both of the towing vehicle and of the trailer, it is already possible to carry out a rough estimation of the instantaneous center of gravity in the longitudinal direction of the vehicle.

In a further preferred variant, the actual values and the second values or the end values are passed on to an electronic stabilization system for influencing the driving behavior of the vehicle. The electronic stabilization system can use the actual values and the second values or the end values for stabilizing the driving behavior of the vehicle, in particular for preventing tipping over during cornering. The reliability of the electronic stabilization system is increased in this manner. Furthermore, further systems, for example a rolling controller (controlled axle damper), can take into account the actual center of gravity of the vehicle and further increase the safety of the vehicle by virtue of the fact that these systems tend to detect critical driving situations.

In one particularly advantageous embodiment, at least one threshold value of a state variable of the electronic stabilization system is defined as a function of the actual values and the second values. By adapting the threshold value to the center of gravity it is possible to detect critical driving situations more quickly and react suitably to them.

In one further preferred embodiment, a maximum permissible attitude angle, a maximum permissible transversal acceleration and/or a maximum permissible yaw rate are used as threshold value of the state variable. The three aforementioned state variables are particularly critical for the driving dynamics. In order to prevent lateral tipping of the vehicle during cornering, it is imperative, for example, that the transversal acceleration should not exceed a maximum permissible threshold value.

In a further preferred embodiment, after the vehicle has been stationary for a certain time, the threshold value of the state variable is defined by renewed determination of the actual values and the second values. During the time when the vehicle was stationary the center of gravity may have been changed so that renewed determination of these values is necessary. Continuous determination of the center of gravity of the vehicle is of course also possible so that even variations in the center of gravity while the vehicle is traveling, in particular due to the displacement of inadequately secured loads, can be determined.

The abovementioned object is also achieved by utilizing a device having at least two displacement sensors for determining the spring compression travel values on the at least one sprung axle of the vehicle, having at least one sensor for determining the at least one transversal dynamics variable, and having actual value acquisition elements for determining an actual value for the height of the center of gravity of the vehicle from the measured spring compression travel values and their temporal variation, and the at least one transversal dynamics variable.

With the exemplary device it is advantageously possible to determine the actual height of the center of gravity of the vehicle. The displacement sensors may be mounted as part of a pneumatic suspension unit on the wheels of the at least one sprung axle of the vehicle. Such displacement sensors are frequently already installed on a series production basis in vehicles so that no increased cost is incurred for the device.

One preferred exemplary embodiment of the device includes at least two pressure sensors for determining the wheel loads on the at least one sprung axle of the vehicle, actual value acquisition elements for determining an actual value for the center of gravity in the longitudinal and/or transversal direction of the vehicle, and/or an actual value for the total weight of the vehicle from the measured wheel loads. The pressure sensors may, for example, be integrated into pneumatic suspension units of the at least one sprung axle of the vehicle. The actual value acquisition elements for determining the actual values of the center of gravity can be formed by part of a program running on a microprocessor. However, it is also possible to implement them as hardware.

A further preferred embodiment of the device includes second value acquisition elements for determining a second value for the height of the center of gravity from the measured wheel loads and their temporal variation and the at least one transversal dynamics variable, and end value acquisition elements for determining an end value for the height of the center of gravity of the vehicle from the actual value and the second value. By using the device it is possible to determine the instantaneous value of the height of the center of gravity in two different ways, which permits the respective perusals to be checked. The second value acquisition elements can be formed here, as can the end value acquisition elements, by part of a program which runs on a microprocessor, but it is also possible to implement them as hardware.

A further advantageous embodiment includes an electro-pneumatic brake system, second value acquisition elements for determining a second value for the center of gravity in the longitudinal and/or transversal direction of the vehicle, and/or a second value for the total weight of the vehicle on the basis of a mass calculation of the electro-pneumatic brake system, and end value acquisition elements for determining respective end values for the center of gravity in the longitudinal direction of the vehicle and/or the center of gravity in the transversal direction of the vehicle and/or the total weight of the vehicle from the actual values and the second values. The electro-pneumatic brake system carries out a mass calculation in order to adapt braking processes to the instantaneous mass of the vehicle. The second values which are obtained on the basis of this mass determination can be used to check the respective actual values. It is advantageous that the electro-pneumatic brake system is present in many vehicles on a series production basis and is correspondingly available for concurrent use.

Further features and advantages of the invention emerge from the following description of an exemplary embodiment of the invention, with reference to the figures of the drawing which show details which are essential to the invention, and from the claims. The individual features can each be implemented individually in themselves or a plurality of them can be implemented in any desired combination in different embodiments of the invention.

Other objects, advantages and novel features of the present invention will become apparent from the following detailed description of the invention when considered in conjunction with the accompanying drawings.

### BRIEF DESCRIPTION OF THE DRAWINGS

An exemplary embodiment of the invention is illustrated in the schematic illustration and will be explained in the following description. In the drawings:

FIG. 1 shows a side view of a vehicle;

FIG. 2 shows the vehicle from FIG. 1 in a bottom view; and

FIG. 3 shows a schematically illustrated embodiment of the device according to the invention for determining the center of gravity of the vehicle shown in FIG. 1.

### DETAILED DESCRIPTION OF THE DRAWINGS

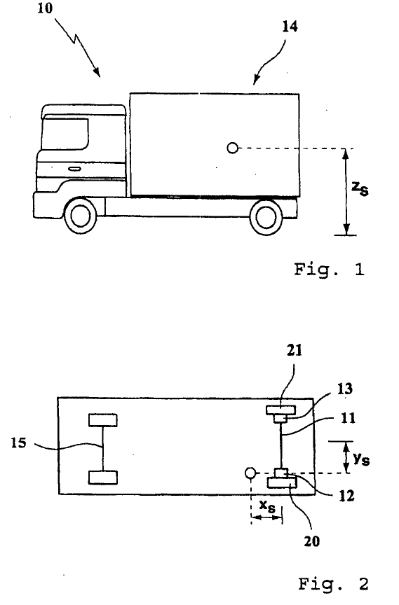

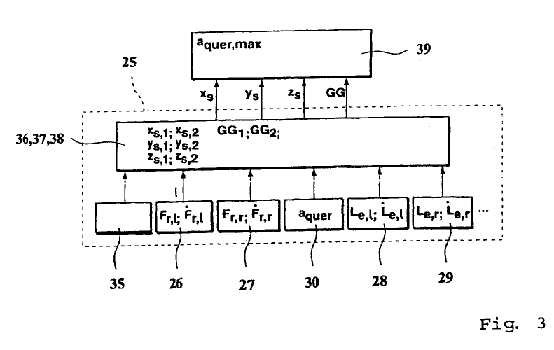

FIGS. 1 and 2 show a towing vehicle 14 which may form a vehicle 10 together with a trailer (not illustrated in the drawings). The towing vehicle 14 has a front axle 15 with leaf suspension and a rear axle 11 with pneumatic suspension. On the rear axle 11, a left-hand pneumatic suspension unit 12 is mounted on a left-hand rear wheel 20 and a right-hand pneumatic suspension unit 13 is mounted on a right-hand rear wheel 21.

Each of the two pneumatic suspension units 12, 13 include one or more pressure sensors 26, 27 (illustrated in FIG. 3) and one or more displacement sensors 28, 29. The displacement sensor 28 measures a spring compression travel value L_{e,1} of the left-hand rear wheel 20 and determines a variation in the spring compression travel value \dot{L}_{e,1} therefrom. A spring compression travel value L_{e,r} and a variation in the spring compression travel value \dot{L}_{e,r} of the right-hand rear wheel 21 are correspondingly determined using the displacement sensor 29. Analogously, a wheel load F_{r,1} of the left-hand rear wheel 20 is determined using the pressure sensor 26, and a variation in the wheel load \dot{F}_{r,1}, is determined therefrom. Likewise, a wheel load F_{r,r} and a variation in the wheel load \dot{F}_{r,r} of the right-hand rear wheel 21 are determined by using the pressure sensor 27.

The exemplary displacement sensors 28, 29 and the pressure sensors 26, 27 are part of a device 25 (shown in FIG. 3) for determining the center of gravity of the vehicle 10. In addition, the device 25 also includes a sensor 30 for determining a transversal acceleration a_{quer} of the vehicle 10 and an electro-pneumatic brake system 35 which determines a mass distribution of the vehicle 10.

From the abovementioned input variables, an actual value z_{s,1} is determined in an actual value acquisition element 36 of the device 25, and a second value z_{s,2} for the height of the center of gravity of the vehicle 10 is determined in a second value acquisition element 37.

An end value zₛ for the height of the center of gravity of the vehicle 10 is determined from the values z_{s,1} and z_{s,2} in end value acquisition element 38, and is transferred as an output variable to an electronic stabilization system 39. The actual value acquisition element 36, the second value acquisition element 37 and the end value acquisition element 38 are implemented, for example, by use of a microprocessor. In an analogous fashion, an end value xₛ for the center of gravity in the longitudinal direction of the vehicle is determined from an actual value x_{s,1} and a second value x_{s,2} for the center of gravity in the longitudinal direction of the vehicle, and is transferred to the electronic stabilization system 39.

An end value yₛ for the center of gravity in the transversal direction of the vehicle, which is determined from an actual value y_{s,1} and a second value y_{s,2} for the center of gravity in the transversal direction of the vehicle, is transferred in an analogous fashion. An actual value GG₁ for the total weight of the vehicle 10 is determined from the wheel loads F_{r,1}, F_{r,r} in the actual value acquisition elements 36. A second value GG₂ for the total weight of the vehicle 10 is determined on the basis of the mass calculation of the electro-pneumatic brake system 35 in the second value acquisition element 37. An end value GG for the total weight of the vehicle 10 is determined from the actual value GG₁ and the second value GG₂ in the end value acquisition element 38, and transferred to the electronic stabilization system 39.

The output variables of the exemplary device 25 are used in the electronic stabilization system 39 to define threshold values of state variables, for example a maximum transversal acceleration a_{quer,max}.

In additional embodiments, further sensors can be provided in the device 25, in particular sensors which supply further transversal dynamics variables. These include, for example, a steering angle, a vehicle speed, a yaw rate, a steering speed, a wheel speed or a vehicle basic stabilization elements.

The device may take into account sensor values supplied both by the towing vehicle 14 and also by a trailer. The actual values determined at the trailer and second values can be transferred to the towing vehicle 14, and conclusions can be drawn about the actual center of gravity of the vehicle 10 from the actual values and the second values for the towing vehicle 14 and the trailer. The same applies if there is a semi-trailer instead of the trailer.

The foregoing disclosure has been set forth merely to illustrate the invention and is not intended to be limiting. Since modifications of the disclosed embodiments incorporating the spirit and substance of the invention may occur to persons skilled in the art, the

1-15. (canceled)

16. A method for determining mass-related variables of a vehicle, said method comprising:
measuring spring compression travel values on at least one sprung axle of the vehicle;
determining temporal variation of the measured spring compression travel values;
determining at least one transversal dynamics variable describing transversal dynamics of the vehicle; and
determining an actual value of a height of a center of gravity of the vehicle from the measured spring compression travel values, their temporal variation and the at least one transversal dynamics variable.

17. The method as claimed in claim 16, further comprising:
measuring wheel loads on at least one sprung axle of the vehicle; and
determining at least one of an actual value of the center of gravity in a longitudinal direction of the vehicle, an actual value of the center of gravity in a transversal direction of the vehicle, and an actual value of a total weight of the vehicle from the measured wheel loads.

18. The method as claimed in claim 17, further comprising:
measuring wheel loads on at least one sprung axle of the vehicle;
determining a second value of the height of the center of gravity of the vehicle from the measured wheel loads, their temporal variation, and at least one transversal dynamics variable which describes the transversal dynamics of the vehicle; and
determining an end value of the height of the center of gravity of the vehicle from the actual value and the second value.

19. The method as claimed in claim 18, further comprising:
determining on the basis of a mass calculation of an electro-pneumatic brake system of the vehicle at least one of a second value of the center of gravity in the longitudinal direction of the vehicle, a second value of the center of gravity in the transversal direction of the vehicle, and a second value of the total weight of the vehicle; and
determining from the actual values and the second values respectively associated end values for at least one of the center of gravity in the transversal direction of the vehicle, the center of gravity in the longitudinal direction of the vehicle, and the total weight of the vehicle.

20. The method as claimed in claim 16, further comprising the acts of using as transversal dynamics variables at least one of a steering angle, transversal acceleration, vehicle speed, a yaw rate, a steering speed, a wheel speed, and a vehicle basic stabilization parameter.

21. The method as claimed in claim 19, further comprising, in a commercial vehicle with a semi-trailer, determining the actual values and the second values for both the commercial vehicle and for the semi-trailer.

22. The method as claimed in claim 19, further comprising, for a vehicle being a towing vehicle with a trailer, determining the actual values and the second values for both the towing vehicle and for the trailer.

23. The method as claimed in claim 19, further comprising the act of passing the actual values and the second values to an electronic stabilization system for influencing the driving behavior of the vehicle.

24. The method as claimed in claim 23, further comprising defining at least one threshold value of a state variable of the electronic stabilization system as a function of the actual values and the second values.

25. The method as claimed in claim 24, further comprising using as the threshold value of the state variable at least one of a maximum permissible attitude angle, a maximum permissible transversal acceleration, and a maximum permissible yaw rate.

26. The method as claimed in claim 24, further comprising defining the threshold value of the state variable, after the vehicle is stationary for a selected time period, by renewing a determination of the actual values and the second values.

27. A device for determining mass-related variables of a vehicle, said device comprising:
at least two displacement sensors for determining spring compression travel values on at least one sprung axle;
at least one sensor for determining at least one transversal dynamics variable; and
actual value acquisition elements for determining an actual value of a height of a center of gravity of the vehicle from the measured spring compression travel values, temporal variation thereof, and the at least one transversal dynamics variable.

28. The device as claimed in claim 27, further comprising:
at least two pressure sensors for measuring wheel loads on the at least one sprung axle; and
actual value acquisition elements for determining at least one of an actual value of the center of gravity in the longitudinal direction of the vehicle, an actual value of the center of gravity in the transversal direction of the vehicle, and an actual value of a total weight of the vehicle from the measured wheel loads.

29. The device as claimed in claim 28, further comprising:
at least two pressure sensors for determining the wheel loads on the at least one sprung axle;
second value means for determining a second value for the height of the center of gravity of the vehicle from the wheel loads, their temporal variation and the at least one transversal dynamics variable; and
end value acquisition elements for determining an end value of the height of the center of gravity of the vehicle from the actual value and the second value.

30. The device as claimed in claim 27, further comprising:
an electro-pneumatic brake system;
second value acquisition elements for determining, based on a mass calculation of the electro-pneumatic brake system, at least one of a second value of the center of gravity in the longitudinal direction of the vehicle, a second value of the center of gravity in the transversal direction of the vehicle, and a second value for a total weight of the vehicle; and
end value acquisition elements for determining, from the actual values and the second values, at least one of respective end values of the center of gravity in the longitudinal direction of the vehicle, the center of gravity in the transversal direction of the vehicle, and the total weight of the vehicle.

31. A vehicle electronic stabilization system, comprising:
sensors for measuring spring compression travel values on at least one sprung axle of the vehicle;
value acquisition elements for determining temporal variation of the measured spring compression travel values and at least one transversal dynamics variable describing transversal dynamics of the vehicle; and
additional value acquisition elements for determining an actual value of a height of a center of gravity of the vehicle from the measured spring compression travel values, their temporal variation and the at least one transversal dynamics variable.

32. The stabilization system according to claim 31, further comprising:
sensors for measuring wheel loads on at least one sprung axle of the vehicle; and
value acquisition elements for determining at least one of an actual value of the center of gravity in a longitudinal direction of the vehicle, an actual value of the center of gravity in a transversal direction of the vehicle, and an actual value of a total weight of the vehicle from the measured wheel loads.

33. The stabilization system according to claim 31, further comprising:
sensors for measuring wheel loads on at least one sprung axle of the vehicle;
value acquisition elements for determining a second value of the height of the center of gravity of the vehicle from the measured wheel loads, their temporal variation, and at least one transversal dynamics variable which describes the transversal dynamics of the vehicle; and
further value acquisition elements for determining an end value of the height of the center of gravity of the vehicle from the actual value and the second value.

34. The stabilization system according to claim 31, further comprising:
value acquisition elements for determining, on the basis of a mass calculation of an electro-pneumatic brake system of the vehicle, at least one of a second value of the center of gravity in the longitudinal direction of the vehicle, a second value of the center of gravity in the transversal direction of the vehicle, and a second value of the total weight of the vehicle; and
further value acquisition elements for determining from the actual values and the second values respectively associated end values for at least one of the center of gravity in the transversal direction of the vehicle, the center of gravity in the longitudinal direction of the vehicle, and the total weight of the vehicle.
